(19) United States
(12) Patent Application Publication
(10) Pub. No.: US 2015/0186193 A1
(43) Pub. Date: Jul. 2, 2015

(54) GENERATION OF CLIENT-SIDE APPLICATION PROGRAMMING INTERFACES

(71) Applicant: Microsoft Corporation, Redmond, WA (US)

(72) Inventors: Navendu Jain, Seattle, WA (US); Rahul Potharaju, West Layfette, IN (US)

(73) Assignee: Microsoft Corporation, Redmond, WA (US)

(21) Appl. No.: 14/142,432

(22) Filed: Dec. 27, 2013

(51) Int. Cl. G06F 9/54

(52) U.S. Cl. CPC G06F 9/541; G06F 2209/541

(57) ABSTRACT

Techniques for generating a client-side Application Programming Interface (API) are described herein. The techniques may include analyzing source code that is related to an API of a service provider and/or content that describes the source code and/or the API of the service provider. The analysis may identify characteristics of the API of the service provider, such as routines, characteristics of the routines, data constructs, characteristics of the data constructs, and so on. The techniques may also include generating a representation to represent the characteristics of the API of the service provider and generating a client-side API based on the representation. The client-side API may include a library of client-side routines and/or data constructs that provide access to routines and/or data constructs that are made available via the API of the service provider.

### BACKGROUND

Application Programming Interfaces (APIs) of service providers provide clients with access to services of the service providers, such as a web services. These APIs are often complex and extensive, providing difficulties for the client when the client attempts to understand and use the APIs. For example, an API that includes hundreds or thousands of different function calls may require a client to spend a substantial amount of time reviewing documentation for the API (if any) and understanding the function calls. This amount of time may be further lengthened when the client decides to re-implement a server-side object or an API call provided by the service provider in its own preferred client-side language. For instance, consider a client-side application being written in Python wishing to communicate with a web service written using C# (ASP.NET) on the server-side. Here, the client may decide to write a wrapper around the web service API in Python to simplify subsequent calls. Further, a complex or extensive server-side API may make verification of code implemented at a client more difficult. Additionally, since any changes to a server-side API may disrupt code that interacts with an API on the client-side, a client may need to monitor the server-side API for changes. With the growing complexity of API calls provided by service providers, there is an increasing need to provide client-side mechanisms that enable access to server-side APIs.

### SUMMARY

This disclosure describes techniques and architectures for generating client-side APIs for APIs of service providers. In some instances, a computing device may obtain source code that is related to an API of a service provider and/or content that describes the source code and/or the API of the service provider. The computing device may analyze the source code and/or content to identify characteristics of the API of the service provider, such as a function routine that is made available via the API of the service provider, a parameter of the routine, a type of the parameter, an order of multiple parameters of the routine, a type of return of the routine, a data construct, a data field of a data construct, and so on. In some instances, the computing device may utilize Natural Language Processing (NLP), other textual analysis, binary analysis, statistics, or their combination, to identify a term in the content and/or the source code that relates to a routine and/or a data construct that is made available via the API of the service provider.

The computing device may then generate a representation with nodes that represent the characteristics of the API of the service provider. The representation may include a parse tree, a graph representation, etc. In some instances, a representation may be generated for each routine that is made available via the API of the service provider. The computing device may generate a client-side API that provides access to the API of the service provider. The client-side API may include a library of client-side routines and/or data constructs that provide access to routines and/or data constructs that are made available via the API of the service provider. The client-side API may additionally, or alternatively, include content in a natural language format that describes the source code.

This Summary is provided to introduce a selection of concepts in a simplified form that are further described below in the Detailed Description. This Summary is not intended to identify key or essential features of the claimed subject matter, nor is it intended to be used to limit the scope of the claimed subject matter.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example architecture in which techniques described herein may be implemented.

FIG. 2 illustrates an example representation that is generated from source code that is related to an API of a service provider.

FIG. 3 illustrates an example representation that is generated from descriptive content that describes source code and/or an API of a service provider.

FIG. 4 illustrates an example representation that is generated from source code and descriptive content.

FIG. 5 illustrates an example interface that may provide API documentation.

FIG. 6 illustrates an example interface of a software development environment that may implement a client-side API.

FIG. 7 illustrates an example process to generate a client-side API based on an analysis of source code that is related to an API of a service provider and/or content that describes the source code and/or the API of the service provider.

FIG. 8 illustrates an example process to retrieve source code that is related to an API of a service provider and/or content that describes the source code and/or the API of the service provider, to generate a client-side API, to test the client-side API, and to make the client-side API available.

### DETAILED DESCRIPTION

Application Programming Interfaces (APIs) of service providers are often complex and extensive, requiring clients to handle a multitude of tasks, such as making requests to an application server, fetching response data and storing this data inside objects which mimic data structures on the server-side. This causes clients (e.g., client devices, users of client devices, entities, etc.) to spend substantial amounts of time to understand and use the APIs. As a growing number of clients utilize APIs of service providers, there is an increasing need to provide client-side mechanisms that enable access to server-side APIs.

This disclosure describes techniques and architectures for generating client-side libraries consisting of APIs to access APIs of service providers. In some instances, a client-side API may enable clients, such as client devices, developers, other users, and so on, to more efficiently access an API of a service provider (e.g., may reduce developer efforts to access the API of the service provider).

To generate a client-side API, a computing device may retrieve source code that is related to an API of a service provider and/or content that describes the source code and/or the API of the service provider. To illustrate, the computing device may retrieve content that describes an API of a service provider, such as a technical document from an online source, postings from a developer blog, and so on. In another illustration, the computing device may retrieve underlying source code for routines and/or data constructs of a service provider that are publicly exposed (e.g., publicly accessible via a software development kit (SDK) or library) by the API of the service provider.

The computing device may analyze the source code and/or the content to identify characteristics of the API of the service provider. The characteristics may include a routine that is made available via the API, a parameter of the routine, a type of the parameter, an order of multiple parameters of the routine, a type of return of the routine, a data construct, a data field of a data construct, and so on. In some instances, the computing device may utilize Natural Language Processing (NLP), other textual analysis, binary analysis (e.g., binary-to-text convertor, binary decoder, etc.), and/or statistics to identify a term in the content and/or the source code that relates to a routine and/or a data construct that is made available via the API.

The computing device may then generate a representation(s) to represent the characteristics of the API of the service provider. The representation(s) may include, for example, a parse tree, a graph representation, or other representation, with nodes that represent the characteristics of the API. To illustrate, the computing device may generate a semantic parse tree for a routine of the API of the service provider, with nodes that represent a parameter of a routine, a type of the parameter, an order of multiple parameters of the routine, or a type of return of the routine. A representation may be generated for each routine that is made available via the API of the service provider.

Based on the representation(s), the computing device may generate a client-side API that provides access to the API of the service provider. The client-side API may include a library of client-side routines and/or data constructs that provide access to routines and/or data constructs that are made available via the API of the service provider. The client-side API may additionally, or alternatively, include content that describes the source code in a natural language format. By creating a client-side API that provides access to the API of the service provider, the techniques and architectures may assist clients (e.g., client devices, users of client devices, entities, etc.) in understanding and utilizing the API of the service provider. In one example, a software development environment, such as a development environment that implements an intelligent code auto completion tool (e.g., IntelliSense®), may utilize the client-side API to assist a user in understanding and utilizing the API of the service provider. In other examples, the client-side API may be utilized in other manners and/or by other entities, user, devices, and so on.

This brief introduction is provided for the reader's convenience and is not intended to limit the scope of the claims, nor the proceeding sections. Furthermore, the techniques described in detail below may be implemented in a number of ways and in a number of contexts. Example implementations and contexts are provided with reference to the following figures, as described below in more detail. It is to be appreciated, however, that the following implementations and contexts are only examples of many.

### Example Architecture

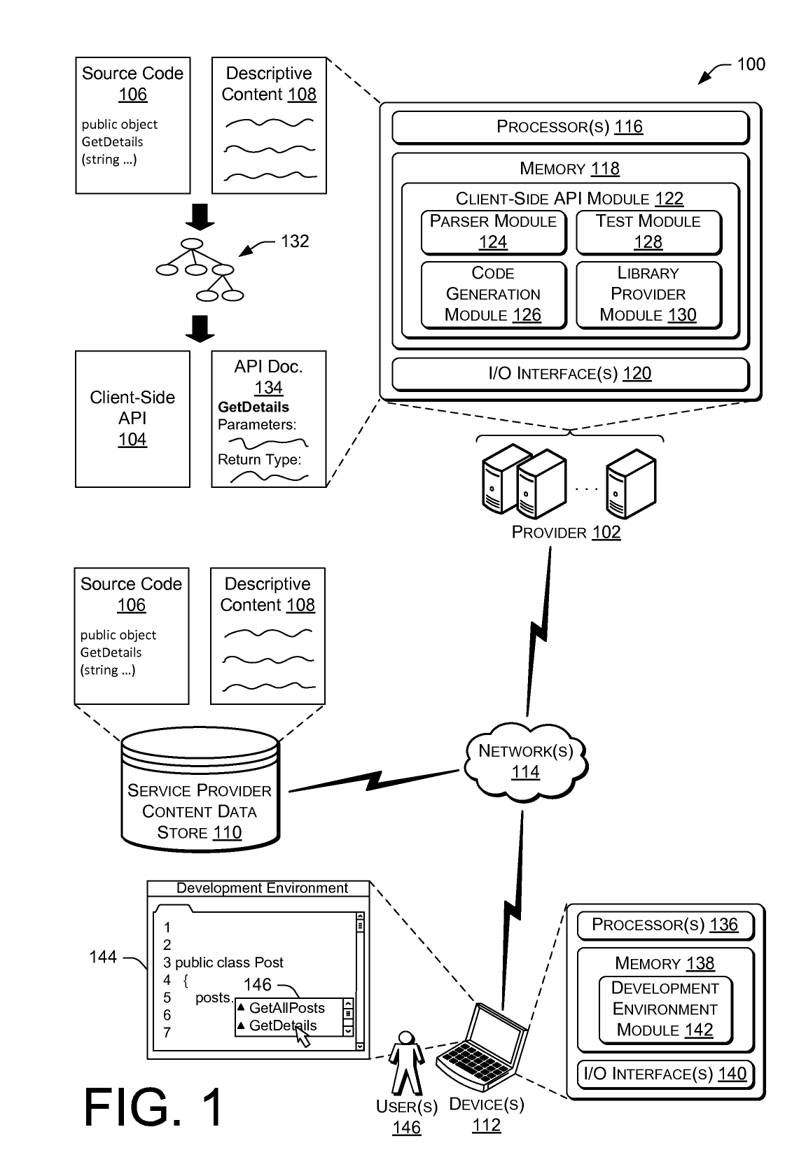

FIG. 1 illustrates an example architecture 100 in which techniques described herein may be implemented. The architecture 100 includes a provider 102 configured to generate a client-side Application Programming Interface (API) 104 and perform other operations that are related to the client-side API 104. The client-side API 104 may be generated based on an analysis of source code 106 and/or descriptive content 108 obtained from a service provider content data store 110. The client-side API 104 may be provided to one or more computing devices 112 (hereinafter “the device 112”) via one or more networks 114 (hereinafter “the network 114”).

The provider 102 may include one or more computing devices, such as one or more desktop computers, laptop computers, servers, and the like. The one or more computing devices may be configured in a cluster, data center, cloud computing environment, or a combination thereof. In one example, the one or more computing devices provide cloud computing resources, including computational resources, network resources, storage resources, and the like, that operate remotely to the device 112.

The one or more computing devices of the provider 102 may be equipped with one or more processors 116, memory 118, and/or one or more input/output interfaces 120 (hereinafter “the I/O interface 120”). The one or more processors 116 may include a central processing unit (CPU), graphics processing unit (GPU), a microprocessor, and so on. The I/O interface 120 may include a network interface, display device interface, and so on.

The memory 118 may include software functionality configured as one or more “modules.” As used herein, the term “module” is intended to represent example divisions of software for purposes of discussion, and is not intended to represent any type of requirement or required method, manner or organization. Accordingly, while various “modules” are discussed, their functionality and/or similar functionality could be arranged differently (e.g., combined into a fewer number of modules, broken into a larger number of modules, etc.). Further, while certain functions are described herein as being implemented as software modules configured for execution by a processor, in other embodiments, any or all of the functions may be implemented (e.g., performed) in whole or in part by hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), etc.

As illustrated in FIG. 1, the memory 118 may include a client-side API module 122 configured to perform various operations related to the client-side API 104. The client-side API 104 may provide access to an API of a service provider (also referred to as a server-side API). An API of a service provider may generally specify a set of routines and/or data constructs of the service provider that are made publicly available to developers, applications, and other entities. This set of routines and/or data constructs may take the form of a library or other structure, such as a software development kit (SDK). A service provider may generally make routines and/or data constructs available via an API so that developers, applications, and other entities may utilize functionality of the service provider. To illustrate, in a web context, an API of a web service provider may specify a set of Hypertext Transfer Protocol (HTTP) request messages and a set of response messages to the HTTP request messages. The API of the web service provider may define what types of information to send for a request message (e.g., parameter types, parameter order, etc.) and/or what types of information is returned (e.g., return types, etc.). To perform operations related to the client-side API 104, the client-side API module 122 may include a parser module 124, a code generation module 126, a test module 128, and a library provider module 130.

The parser module 124 may be configured to obtain the source code 106 and/or the descriptive content 108 from the service provider content data store 110. The source code 106 may comprise code that is related to an API of a service provider. For example, the source code 106 may comprise the underlying code that implements routines and/or data constructs that are made available (e.g., exposed, accessible, etc.) via the API of the service provider, such as a function, method, call, subroutine, object, and so on. The source code 106 may comprise code that has been previously written and compiled for use by the service provider and others.

The descriptive content 108 may describe the source code 106 and/or the API of the service provider. For example, the descriptive content 108 may comprise a document or other content that describes an API of a service provider, such as a technical document from an online source (e.g., a web page for developers to understand an API of a service provider), binary code, content from a software development blog (e.g., posts and other content), and so on. In some instances, the descriptive content 108 may be in a particular format, such as a natural language format, binary format (e.g., binary code), structured format (e.g., extensible markup language (XML), JavaScript Object Notation (JSON), a proprietary format, etc.), and so on. The descriptive content 108 may include textual or binary content created by a service provider that is providing the API (or users associated with the service provider), by a community of users that utilize the API (e.g., software developers), and/or by other entities. As such, the service provider content data store 110 may be associated with a service provider (e.g., a provider of a web service or another type of service), an online environment (e.g., software development web pages, application store, etc.), and/or any other entity.

The parser module 124 may analyze the source code 106 and/or the descriptive content 108 to identify characteristics of the API of the service provider. The characteristics may comprise a routine that is made available via the API of the service provider, a parameter of a routine, a type of a parameter, an order of multiple parameters of a routine, a type of return of a routine, a data construct that is made available via the API of the service provider, a data field of a data construct (e.g., attributes that describe an object), and so on. In some instances, a type of return may be identified for all routines, even if the type of return is void (e.g., does not return anything). The parser module 124 may generally seek to determine a signature for a routine. In some examples, the parser module 124 may analyze all routines and/or data constructs of the source code 104 that are publicly accessible/exposed (e.g., designated as public).

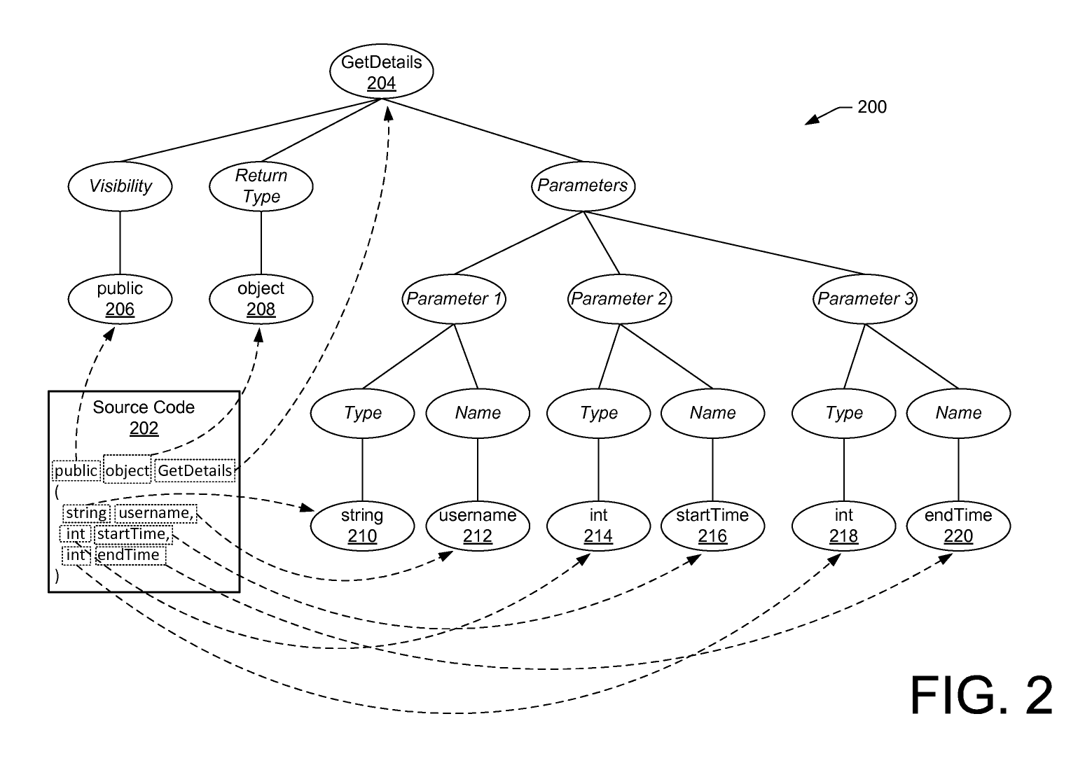

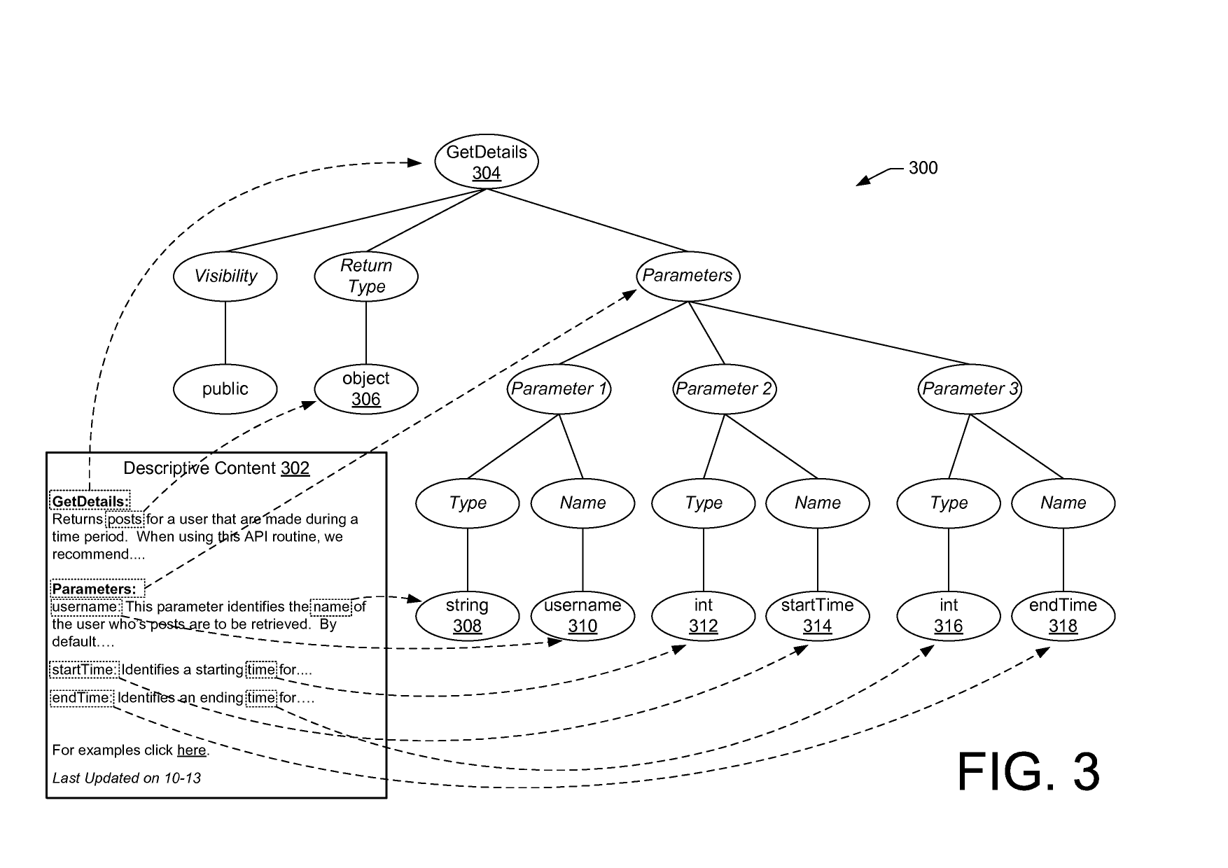

In some implementations, the parser module 124 may analyze the source code 106 and/or the descriptive content 108 with techniques such as Natural Language Processing (NLP), other textual analysis, binary analysis (e.g., binary-to-text conversion, binary decoder, etc.), and/or statistics. The analysis may seek to identify a term in the source code 106 and/or descriptive content 108 that relates to (i) a routine that is made publicly available via the API of the service provider (e.g., a routine of the source code 106), (ii) a characteristic of the routine, (iii) a data construct that is made available via the API of the service provider, and/or (iv) a characteristic of a data construct. Textual analysis may include NLP, Named-Entity Recognition (NER), canonicalization, truncation (e.g., filtering predetermined stop words), expansion (e.g., NER techniques to identify nouns, verbs, etc, synonym finding techniques that utilize knowledge bases, such as WordNet®, to expand terms to include other entities and/or synonyms, and so on), normalization (e.g., reducing terms to their stem forms through the process of stemming), and so on. In one example, utilizing statistics may include computing the frequency distribution of words in the source code 106 and/or the descriptive content 108 by removing predetermined common words (e.g., “a,” “an,” “the,” etc.) in the source code 106 and/or descriptive content 108, computing the top-k statistic to find the most frequently occurring words, and analyzing those words to determine if, for example, they are reserved keywords, commonly used data types, data fields (e.g., new data fields), etc. Example techniques of analyzing source code are described in further detail below in reference to FIG. 2, while example techniques for analyzing descriptive content are described in reference to FIG. 3.

The code generation module 126 may be configured to generate one or more representations 132 that represent the characteristics of the API of the service provider. A representation may include a parse tree (e.g., semantic parse tree, abstract syntax tree, etc.), a graph representation, or other structure that depicts the characteristics in an organized manner. In some instances, a representation may be referred to as an abstract representation. Further, in some instances, a representation is generated for each routine and/or data construct that is made available via the API of the service provider. As discussed in further detail below, a representation may include nodes that each represents a characteristic of a routine. For example, a representation for a routine called “GetDetails” may include a node for a return type of the routine and a node for an input parameter that is passed to the routine.

The code generation module 126 may also be configured to generate the client-side API 104 based on the one or more representations 132. The client-side API 104 may include a library of client-side routines and/or data constructs that provide access to routines and/or data constructs that are exposed via the API of the service provider. For example, the client-side API 104 may comprise a software development kit (SDK) to interface with the API of the service provider. Further, in some instances the client-side API 104 comprises source code that is written in a different programming language than the source code 106 that is related to the API of the service provider. For example, the client-side API 104 may include a routine or a data construct that is coded in a different programming language than a routine or data construct of the source code 106. Alternatively, or additionally, in some instances the client-side API 104 may comprise a wrapper around a routine and/or data construct of a service provider. To illustrate, the client-side API 104 may include a wrapper written in Python that provides access to a web service written in C#.

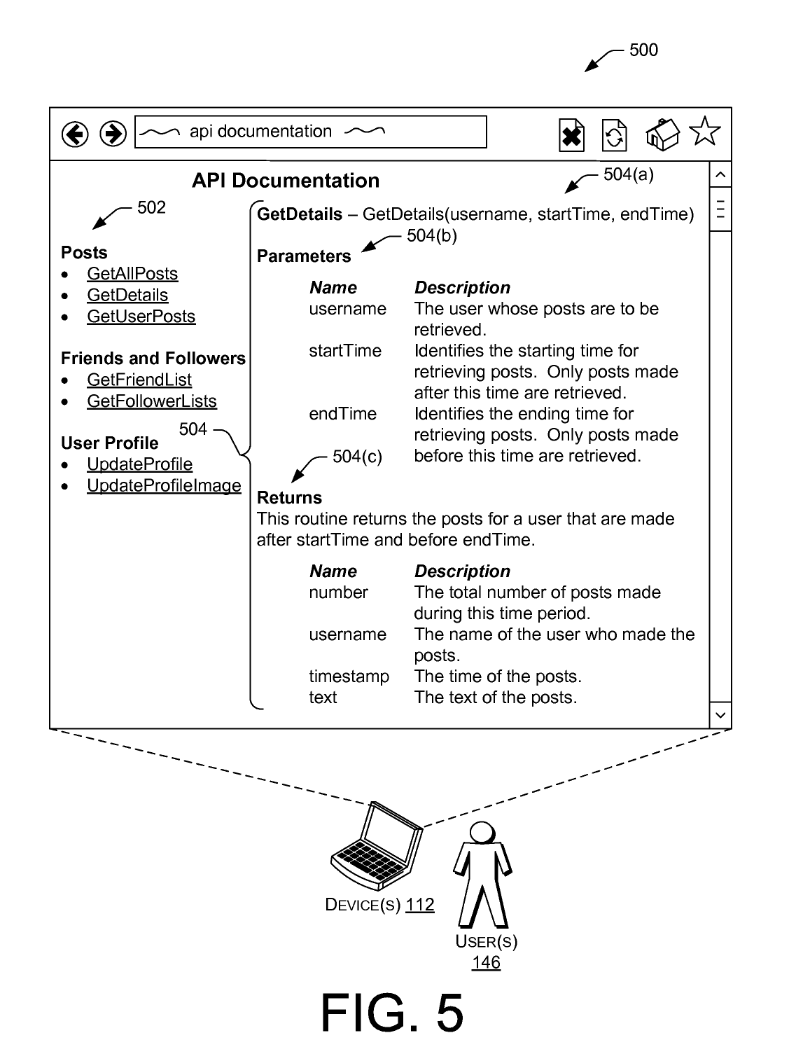

As shown in FIG. 1, the code generation module 126 may also be configured to generate API documentation 134 that describes the source code 106 in a natural language format to accompany the client-side API 104. The API documentation 134 may be generated based on the one or more representations 132. The API documentation 134 may generally describe routines and data constructs that are made available via the API of the service provider. Although the API documentation 134 is illustrated as a separate element to the client-side API 104, in some instances the API documentation 134 is incorporated into the client-side API 104. Example API documentation is described in further detail below in reference to FIG. 5.

The test module 128 may be configured to test the client-side API 104. This may include making a call using some test examples for input parameters, via the client-side API 104, to a routine that is made available via the API of the service provider. For example, the test module 128 may invoke a client-side routine that provides access to a routine of the service provider to determine if the client-side routine satisfies one or more criteria to be classified as functioning properly (e.g., the client-side routine returns information, an error does not occur while calling the client-side routine, etc.). Alternatively, or additionally, the test module 128 may test the client-side API 104 by implementing a client-side data construct (e.g., object) and determining if the client-side data construct satisfies one or more criteria to be classified as functioning properly (e.g., an error does not occur while implementing the client-side data construct, etc.).

The library provider module 130 may be configured to make the client-side API 104 and/or API documentation 134 available to a computing device (e.g., the device 112), an application, a user, or other entity. For example, the client-side API 104 may be sent to the device 112 via the network 114 to be implemented in an integrated development environment (IDE). In another example, the client-side API 104 and/or API documentation 134 may be made available through a web site or other online source. By making the client-side API 104 and/or API documentation 134 available, the API of the service provider may be better understood and efficiently utilized.

Although in the example architecture 100 of FIG. 1 the modules 122-130 are illustrated as being included in the provider 102, one or more of these elements may be included in the device 112 or any other device.

The architecture 100 of FIG. 1 may also include the device 112 to perform various operations based on the client-side API 104 and/or the API documentation 134. The device 112 may comprise a laptop computer, a desktop computer, a smart phone, an electronic reader device, a mobile handset, a personal digital assistant (PDA), a portable navigation device, a portable gaming device, a game console, a tablet computer, a watch, a portable media player, and so on.

The device 112 may be equipped with one or more processors 136, memory 138, and one or more input/output interfaces 140 (e.g., a network interface, display device interface, etc.). The memory 138 may include a development environment module 142 configured to provide a development environment 144, such as an IDE. The development environment 144 may provide tools to assist one or more users 146 (hereinafter “the user 146”) of the device 112 in developing software. The development environment 144 may utilize the client-side API 104 as a library of client-side routines and/or data constructs. As illustrated in FIG. 1, the development environment 144 includes an intelligent code completion tool that displays a window 146 with references to client-side routines of the client-side API 104. As the user 146 in this illustration types the term “posts” in reference to the class “Posts,” the routines “GetAllPosts” and “GetDetails” of the client-side API 104 are displayed in the window 146. These client-side routines correspond to routines of the service provider. The user 146 may select a routine that corresponds to the specified class. As such, the intelligent code completion tool may assist the user 146 in understanding and utilizing the API of the service provider by providing additional API calls and/or documentation.

Although the development environment module 142 is illustrated as being included in the device 112, in some instances the development environment module 142 is included in the provider 102 and/or another device. Thus, in some instances the development environment 144 may be implemented through a remote service, such as a cloud service.

The memory 118, 138, and/or any other memory described herein may include one or a combination of computer-readable media. Computer-readable media may include computer storage media and/or communication media. Computer storage media includes volatile and non-volatile, removable and non-removable media implemented in any method or technology for storage of information such as computer-readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer-readable instructions, data structures, program modules, or other data in a modulated data signal, such as a carrier wave, or other transmission mechanism. As defined herein, computer storage media does not include communication media.

The provider 102, service provider content data store 110, and/or device 112 may communicate via the network 114. The network 114 may include any one or combination of multiple different types of networks, such as cellular networks, wireless networks, Local Area Networks (LANs), Wide Area Networks (WANs), Personal Area Networks (PANs), and the Internet.

### Example Representations

FIG. 2 illustrates an example representation 200 that is generated from source code 202 that is related to an API of a service provider. For ease of illustration, the source code 202 comprises code for a single routine (e.g., a method entitled “GetDetails”). However, it should be appreciated that the source code 202 may include multiple routines and/or data constructs. In this example, the representation 200 corresponds to a type of abstract representation typically called a parse tree, which may generally be created when source code is used.

Here, the source code 202 may be analyzed to identify characteristics that relate to routines and/or data constructs of the service provider. This may include identifying terms that relate to a routine, a characteristic of a routine (e.g., a parameter of the routine, a type of the parameter, an order of multiple parameters of the routine, or a type of return of the routine), a data construct, and/or a characteristic of a data construct (e.g., a data field, such as an attribute that describes an object), and so on. For example, a lexer may tokenize the source code 202 into tokens and subsequently a parser may interpret the tokens based on rules that specify a structure of a programming language. For example, the analysis may identify the source code 202 as written in a particular programming language and seek to identify terms based on rules that are associated with the particular programming language. The rules may generally specify how terms should be arranged (e.g., parenthesis follow a method name) and/or a particular term that corresponds to a structural element (e.g., “int” specifies an “integer” data type). Any identified terms from the analysis may be used to generate the representation 200.

To illustrate, the analysis in FIG. 2 has identified the term “GetDetails” as corresponding to the name of the routine due to the fact that “GetDetails” follows the terms “public object.” Accordingly, a node 204 is added as the root node for the representation 200 to represent the “GetDetails” routine. As noted above, a representation may be created for each routine of source code. The analysis has also identified the term “public” as the visibility (e.g., accessibility, exposure, etc.) of the routine, the term “object” as the return type (in this case, an object return type), the term “string” as a parameter type, the term “username” as the name for the “string” parameter, the term “int” as a parameter type (in this case, an integer), the term “startTime” as the name for the “int” parameter, the term “int” as another parameter type, and the term “endTime” as the name for the other “int” parameter.

Based on the analysis, nodes 206-220 may be added to the representation 200 to represent the characteristics of the routine “GetDetails” in an organized manner. The leaf nodes of the representation 200 (e.g., the nodes 206-220) may be organized according to a particular order. As shown, the visibility node 206 is arranged as the first node on the left-hand side, followed by the return type and the parameters. Each parameter may be represented with its own set of nodes to represent the type of parameter and the name of the parameter. In some instances, by building the representation 200, it may be ensured that the source code 202 adheres to a specific grammar (e.g., that the terms are arranged according to a particular order, that terms are positioned in a particular location, etc.).

FIG. 3 illustrates an example representation 300 that is generated from descriptive content 302 that describes source code and/or an API of a service provider. For ease of illustration, the descriptive content 302 describes a single routine (e.g., a method entitled “GetDetails”). However, it should be appreciated that the descriptive content 302 may describe multiple routines and/or data constructs. In this example, the representation 300 corresponds to a semantic parse tree, which may generally be created when descriptive content is used.

The representation 300 may be generated by analyzing the descriptive content 302 and identifying characteristics that relate to routines and/or data constructs of the service provider. The representation 300 may be generated utilizing techniques such as NLP or other textual analysis to identify terms that relate to a routine, a characteristic of a routine (e.g., a parameter of the routine, a type of the parameter, an order of multiple parameters of the routine, or a type of return of the routine), a data construct, and/or a characteristic of a data construct (e.g., a data field, such as an attribute that describes an object), and so on. Any identified terms from the analysis may be used to generate the representation 300.

As illustrated, the representation 300 may include nodes 304-318 that represent the characteristics of a routine entitled “GetDetails.” For example, the node 304 (e.g., a root node) may represent the name of the routine, the node 306 may represent a return type for the routine, the node 308 may represent a type of the “string” parameter, the node 310 may represent a name of the “string” parameter (in this case, “username”), the node 312 may represent a type of the “integer” parameter, the node 314 may represent a name of the “integer” parameter (in this case, “startTime”), the node 316 may represent a type of the other “integer” parameter, and the node 318 may represent a name of the other “integer” parameter (in this case, “endTime”).

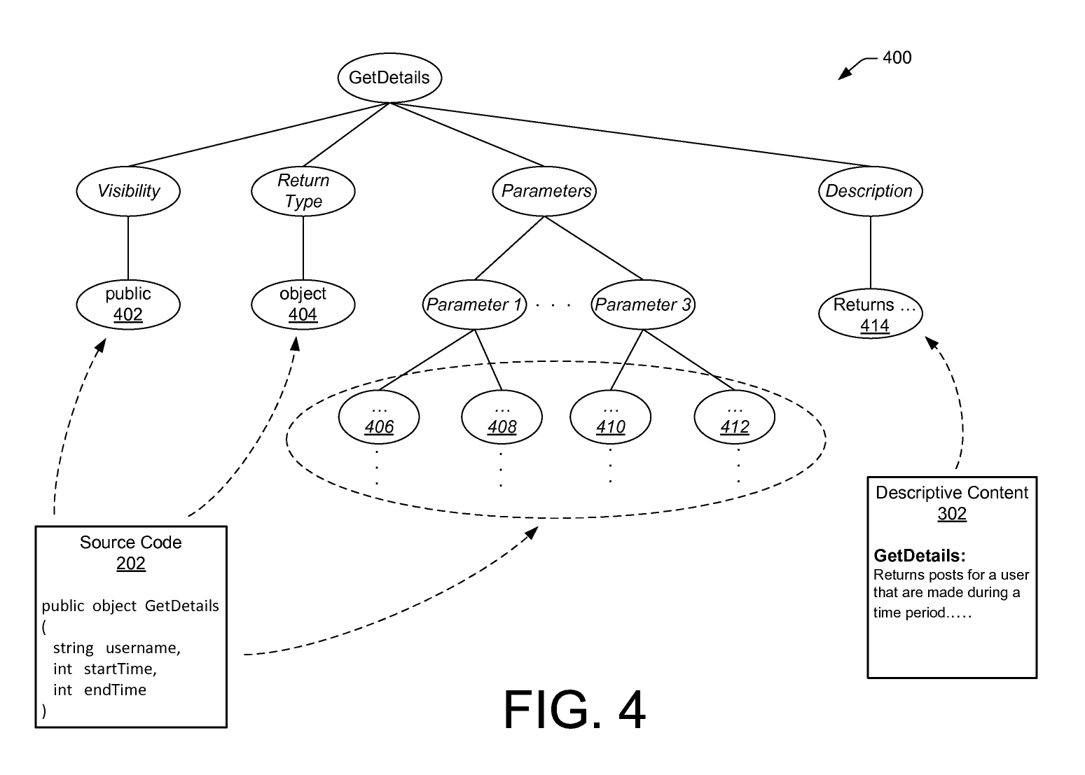

FIG. 4 illustrates an example representation 400 that is generated from the source code 202 and the descriptive content 302. In this example, the representation 400 may be generated by deferring to the source code 202 and relying on the descriptive content 302 when information is missing from the source code 202. That is, the representation 400 may be generated by adding nodes based on an analysis of the source code 202 and, thereafter, adding nodes (if any) based on an analysis of the descriptive content 302. However, in other examples the generation of the representation 400 may defer to the descriptive content 302 first and rely on the source code 202 when information is missing from the descriptive content 302.

As illustrated, the representation 400 includes nodes 402-412 that represent characteristics that are identified from an analysis of the source code 202. Here, the analysis may be similar to that described above in reference to FIG. 2. In addition, the representation 400 includes a node 414 that represents characteristics that are identified based on an analysis of the descriptive content 302. Here, upon adding the nodes 402-412 from the analysis of the source code 202, a node representing a general description of the routine was not included on the representation 400. Accordingly, the node 414 may be added to represent the description. By doing so, the representation 400 may represent as much information as is available about a routine that is made available via an API of a service provider.

### Example API Documentation

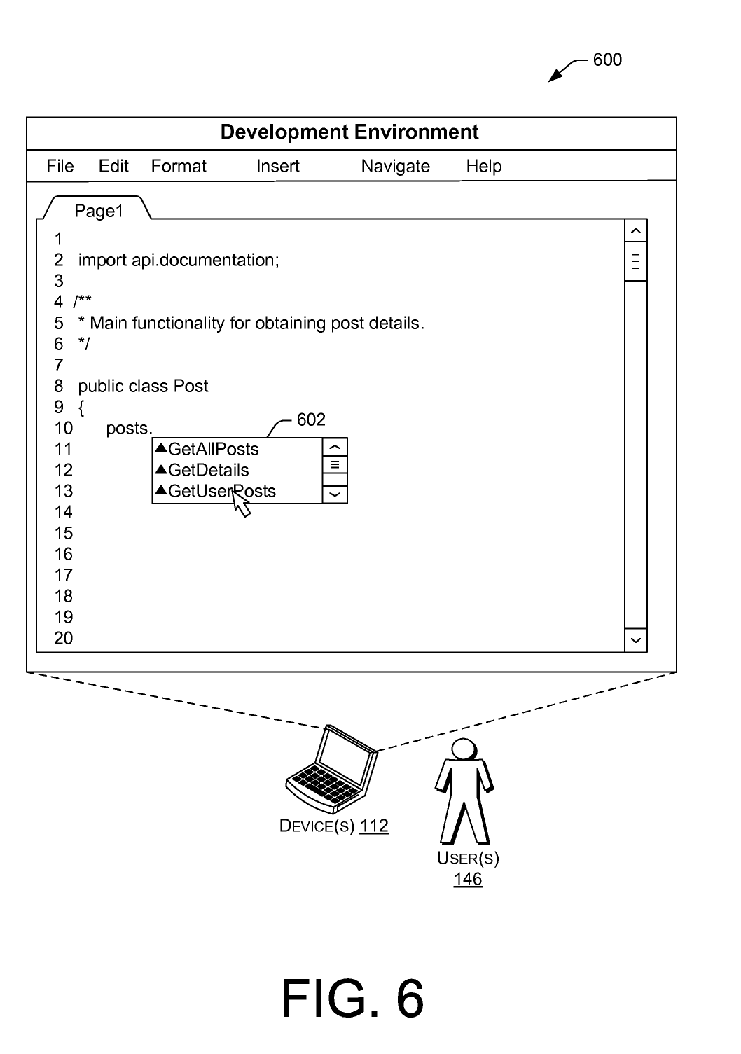

FIG. 5 illustrates an example interface 500 that may provide API documentation to allow a user to perform tasks, such as querying a server-side API with sample data, test functionality of certain server-side API, and/or understand the behavior of different server-side API for a given input. The interface 500 is illustrated as being implemented through a web browser, however, in other examples the interface 500 may be implemented through an application or otherwise. For instance, the API documentation may be provided through an online site that assists software developers in understanding and utilizing an API of a service provider. In another instance, the API documentation is provided through a development environment that assists in developing software, such as the development environment shown in FIG. 6.

The interface 500 may include a section 502 that provides different routines that are made available via the API of the service provider (e.g., “GetAllPosts,” “GetDetails,” “GetUserPosts,” “GetFriendList,” etc). Here, the routines are grouped according to the classes to which the routines belong. To illustrate, the routines “GetAllPosts,” “GetDetails,” and “GetUserPosts” are included in the “Posts” class and, thus, are grouped together.

In this example, the user 146 selects the link to “GetDetails” in the section 502 and the interface 500 displays details of the routine “GetDetails” in a section 504. The details include general details 504(a) about the routine, such as a name of the routine, a name of a parameter, and so on. Parameter details 504(b) describe parameters of the routine. As illustrated, the routine includes a parameter named “username” that identifies the user who's posts are to be retrieved, a parameter named “startTime” that identifies a starting time for retrieving posts, and a parameter named “endTime” identifying an ending time for retrieving posts. Meanwhile, return details 504(c) describe what is returned for the routine. In this example, the routine returns posts for a user that are made after “startTime” and before “endTime.” The return details 504(c) describe various fields that may be returned upon calling the routine (e.g., “number,” “username,” “timestamp,” and “text”). In this case, the routine returns an object with fields defined under the return details 504(c), namely an integer for “number,” a string for “username,” a date field for “timestamp,” and a string for “text.”

In some instances, the API documentation that is provided through the interface 500 may enable developers, applications, and other entities to better understand and utilize an API of a service provider. For example, the API documentation may describe the routines and/or data constructs of the service provider in a natural language format, so that the routines and/or data constructs may be understood.

### Example Development Environment

FIG. 6 illustrates an example interface 600 for a software development environment that may leverage a client-side library (e.g., client-side API). In one example, the software development environment comprises an integrated development environment (IDE) that provides tools to assist in software development. In this example, an application is being implemented using the client-side library inside the software development environment. When doing so, the software development environment may assist the user by leveraging the client-side library to suggest information about a related server-side API to the user. In general, a client-side API may be written in a same programming language as that being used by the user 146 to write source code within the software development environment. To illustrate, if the user 146 is developing software in Python, then a client-side API being leveraged by the software development environment may be written in Python, even if a corresponding API of a service provider is written in a different programming language, such as C#.

The software development environment may include an intelligent code completion tool that provides functionality to auto-complete information. As illustrated, after the user 146 types “posts.” (e.g., an object), a pop-up window 602 appears with routines from the class “Posts” (e.g., “GetAllPosts,” “GetDetails,” and “GetUserPosts”). Here, the software development environment has identified client-side routines that are associated with the class “Posts” based on the client-side API. The client-side routines “GetAllPosts,” “GetDetails,” and “GetUserPosts” provide access to the routines of the service provider “GetAllPosts,” “GetDetails,” and “GetUserPosts.” These client-side routines are grouped within the client-side API into the class “Posts.” The user 146 may select a desired routine in the pop-up window 602 and the text needed to access that routine may be written within the interface next to the text “posts.” To illustrate, if the user 146 is writing code in Python, then the text for the client-side routine that is written in Python may be written in the interface 500. This may be the case even when the corresponding routine of the service provider is written in another language, such as C#. In some instances, if, upon selecting a routine through the pop-up window 602, a parameter is required to be passed to the routine, another pop-up window may be presented with a list of parameters that may be passed to the routine.

By providing an intelligent code completion tool that utilizes the client-side API, the user 146 may utilize routines and/or data constructs that are made available via the API of the service provider without knowing the details of the routines and/or data constructs of the client-side API and/or the service provider. Further, in instances where the API of the service provider is written in a different programming language than that used by the user 146 to write code, the client-side API (which is written in the language that is being used by the user 146) may enable the user 146 to access the API of the service provider without understanding the programming language of the source code of the service provider. This may be advantageous when a developer has a preferred programming language or does not know a programming language of an API of a service provider.

Although the intelligent code completion tool is illustrated in FIG. 6 as being implemented with the pop-up window 602, in other instances this functionality may be implemented through other means, such as through audio outputs from the device 112, text provided in another section of the interface 600, and so on. Further, although the pop-up window 602 shows information about routines, any type of information may be displayed, such as information for a data construct and/or other information about a routine. Further in one example, the pop-up window 602 may display API documentation, such as details about a server-side routine as illustrated in FIG. 5. To illustrate, if the user's mouse indicator hovers over the text “GetDetails” in the pop-up window 602, then details about the “GetDetails” routine may be presented (e.g., text stating “This routine returns the posts for a user that are made after startTime and before endTime,” or other text stating other details of the routine).

### Example Processes

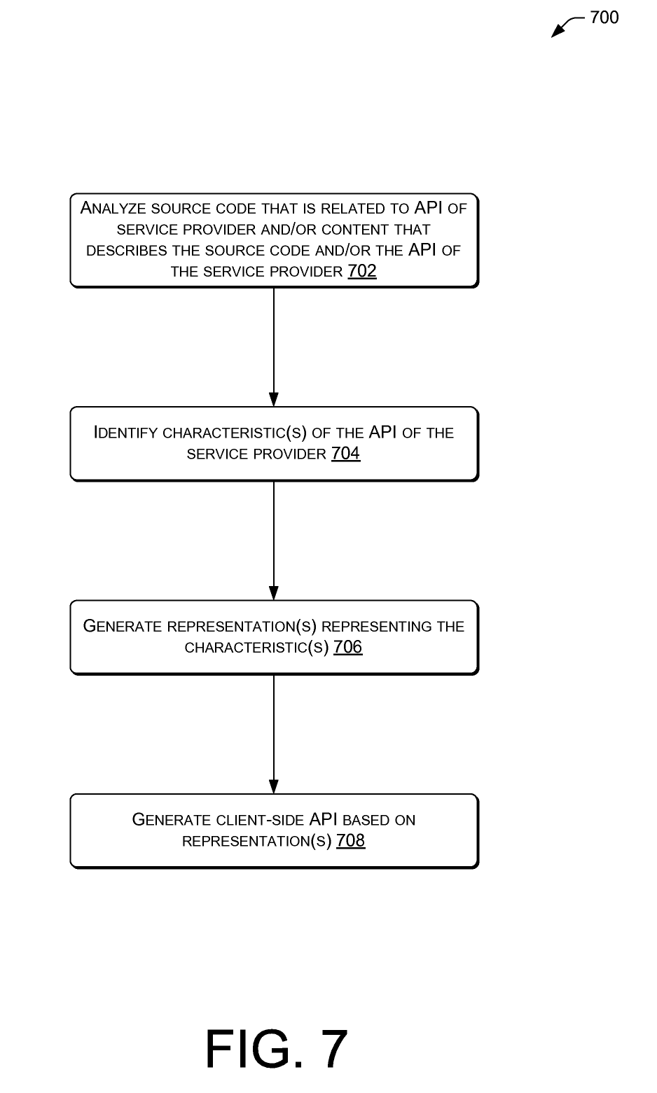

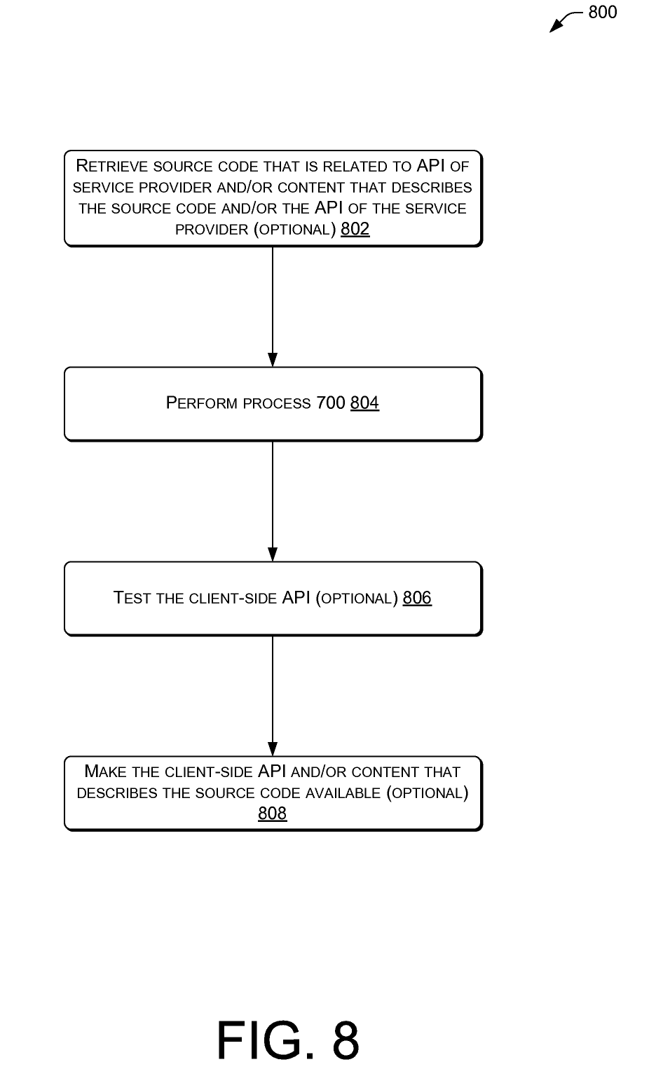

FIGS. 7 and 8 illustrate example processes 700 and 800 for employing the techniques described herein. For ease of illustration processes 700 and 800 are described as being performed in the architecture 100 of FIG. 1. For example, one or more of the individual operations of the processes 700 and 800 may be performed by the provider 102 and/or the device 112. However, the processes 700 and 800 may be performed in other architectures. Moreover, the architecture 100 may be used to perform other processes.

The processes 700 and 800 (as well as each process described herein) are illustrated as a logical flow graph, each operation of which represents a sequence of operations that can be implemented in hardware, software, or a combination thereof. In the context of software, the operations represent computer-executable instructions stored on one or more computer-readable media that, when executed by one or more processors, configure the one or more processors to perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process. Further, any of the individual operations may be omitted.

FIG. 7 illustrates the example process 700 to generate a client-side API based on an analysis of source code that is related to an API of a service provider and/or content that describes the source code and/or the API of the service provider.

At 702, the provider 102 may analyze source code that is related to an API of a service provider and/or content that describes the source code and/or the API of the service provider. In one example, the analysis may include utilizing techniques such as NLP or other textual analysis to identify a term in the content that relates to at least one of a routine of the source code, a characteristic of a routine, a data construct, and/or a characteristic of a data construct. In another example, the analysis may tokenize the source code into tokens and parse the tokens to identify a term in the source code that relates to at least one of a routine of the source code, a characteristic of a routine, a data construct, and/or a characteristic of a data construct. In yet another example, the analysis may include utilizing a binary analysis, statistics, and so on.

At 704, the provider 102 may identify a characteristic(s) of the API of the service provider based on the analysis. The characteristic(s) may comprise a routine that is made available via the API of the service provider, a parameter of the routine, a type of the parameter, an order of multiple parameters of the routine, a type of return of the routine, a data construct that is made available via the API of the service provider, a data field of a data construct (e.g., attributes that describe an object), and so on. In some instances, the provider 102 may identify a first set of characteristics of the API of the service provider based on an analysis of the source code and identify a second set of characteristics of the API of the service provider based on an analysis of the content.

At 706, the provider 102 may generate (e.g., build) a representation(s) representing the characteristic(s) of the API of the service provider. In some instances, the provider 102 may generate a representation for each routine and/or data construct of the source code. Each representation may include nodes that represent characteristics of a routine and/or characteristics of a data construct. Each representation may comprise a parse tree and/or a graph representation. In some instances, the provider 102 may generate a representation by adding nodes to the representation that represent a first set of characteristics of the API of the service provider that are based on an analysis of the source code. Thereafter, the provider 102 may add additional nodes to the representation that represent a second set of characteristics of the API of the service provider (e.g., that are based on an analysis of the content) when the second set of characteristics comprises at least one characteristic in addition to the first set of characteristics.

At 708, the provider 102 may generate a client-side API based on the representation(s). The client-side API may provide access to the API of the service provider. For example, the client-side API may comprise a library of client-side routines and/or data constructs that provide access to routines and/or data constructs of the source code (e.g., routines and/or data constructs that are made available via the API of the service provider). In some instances, the client-side API may provide access to a complete set (e.g., all) of routines and/or data constructs that are publicly exposed via the API of the service provider. The client-side API may be written in a different programming language than the source code that is related to the API of the service provider. The client-side API may also include content that describes the source code in a natural language format.

FIG. 8 illustrates the example process 800 to retrieve source code that is related to an API of a service provider and/or content that describes the source code and/or the API of the service provider, to generate a client-side API, to test the client-side API, and to make the client-side API available.

At 802, the provider 102 may retrieve or otherwise obtain source code that is related to an API of a service provider and/or content that describes the source code and/or the API of the service provider. This may include requesting the content from a data store, such as a data store associated with the provider 102, a data store of the service provider, a data store of an online source (e.g., a developers blog), and so on.

At 804, the provider 102 may perform the process 700 to generate a client-side API based on the source code and/or the content.

At 806, the provider 102 may test the client-side API by making at least one call, via the client-side API, to at least one routine that is made available via the API of the service provider. For example, the provider 102 may invoke a client-side routine that provides access to a routine of the service provider to determine if the client-side routine satisfies one or more criteria to be classified as functioning properly (e.g., the client-side routine returns information, an error does not occur while calling the client-side routine, etc.). Alternatively, or additionally, the provider 102 may test the client-side API by implementing a client-side data construct (e.g., object) to determine if the client-side data construct satisfies one or more criteria to be classified as functioning properly (e.g., an error does not occur while implementing the client-side data construct, etc.).

At 808, the provider may make the client-side API and/or content that describes the source code available. For example, the client-side API may be sent to a device to be implemented in an IDE. In another example, the client-side API and/or content may be made available through a web site or other online source. The content that describes the source code may comprise API documentation, such as the API documentation 134.

### CONCLUSION

Although embodiments have been described in language specific to structural features and/or methodological acts, it is to be understood that the disclosure is not necessarily limited to the specific features or acts described. Rather, the specific features and acts are disclosed herein as illustrative forms of implementing the embodiments.

What is claimed is:

1. A method comprising:
retrieving, by one or more computing devices, at least one of source code that is related to an Application Programming Interface (API) of a service provider, content that describes the source code, or content that describes the API of the service provider;
identifying at least one term that relates to at least one routine of the source code or at least one characteristic of the at least one routine;
generating a representation for the at least one routine, the representation including at least one node that represents the at least one routine or the at least one characteristic of the at least one routine; and
generating a client-side API that provides access to the API of the service provider based at least in part on the representation of the at least one routine.

2. The method of claim 1, wherein the client-side API comprises a library of one or more client-side routines that provide access to the at least one routine of the source code.

3. The method of claim 1, wherein the client-side API comprises source code that is written in a different programming language than the source code that is related to the API of the service provider.

4. The method of claim 1, wherein the client-side API includes content that describes the source code in a natural language format.

5. The method of claim 1, wherein the identifying comprises utilizing at least one of Natural Language Processing (NLP), other textual analysis, or statistics to identify a term, in at least one of the content that describes the source code or the content that describes the API of the service provider, that relates to at least one of a routine of the source code or a characteristic of the routine.

6. The method of claim 1, wherein the at least one characteristic of the at least one routine comprises at least one of a parameter of the at least one routine, a type of the parameter, an order of multiple parameters of the at least one routine, or a type of return of the at least one routine.

7. A system comprising:
one or more processors;
memory communicatively coupled to the one or more processors;
a parser module stored in the memory and configured for execution by the one or more processors to analyze at least one of source code that is related to an Application Programming Interface (API) of a service provider or content that describes the source code or the API of the service provider, wherein the parser module is configured to identify characteristics of the API of the service provider based at least in part on the analysis; and
a code generation module stored in the memory and configured for execution by the one or more processors to generate a representation representing the characteristics of the API of the service provider and to generate, based at least in part on the representation, a client-side API that provides access to the API of the service provider.

8. The system of claim 7, wherein the client-side API comprises a library of at least one of a client-side routine that provides access to a routine that is made available via the API of the service provider or a client-side data construct that provides access to a data construct that is made available via the API or source code of the service provider.

9. The system of claim 7, wherein the characteristics of the API of the service provider comprise at least one of a routine that is made available via the API of the service provider, a parameter of the routine, a type of the parameter, an order of multiple parameters of the routine, or a type of return of the routine.

10. The system of claim 7, further comprising:
a test module stored in the memory and configured for execution by the one or more processors to test the client-side API by making at least one call, via the client-side API, to at least one routine that is made available via the API of the service provider.

11. The system of claim 7, wherein the client-side API comprises a library of at least one of a client-side routine or a client-side data construct that is coded in a different programming language than that of the source code that is related to the API of the service provider.

12. The system of claim 7, further comprising:
a library provider module stored in the memory and configured for execution by the one or more processors to make the client-side API available to an integrated development environment.

13. The system of claim 7, wherein:
the parser module is configured for execution by the one or more processors to:
analyze the source code that is related to the API of the service provider and analyze the content that describes the API of the service provider; and
identify a first set of characteristics of the API of the service provider based at least in part on the analysis of the source code and identify a second set of characteristics of the API of the service provider based at least in part on the analysis of the content; and
the code generation module is configured for execution by the one or more processors to generate a representation by adding nodes to the representation that represent the first set of characteristics of the API of the service provider and adding additional nodes to the representation that represent the second set of characteristics of the API of the service provider when the second set of characteristics comprises at least one characteristic in addition to the first set of characteristics.

14. The system of claim 7, wherein the parser module is configured for execution by the one or more processors to analyze the content that describes the API of the service provider by utilizing at least one of Natural Language Processing (NLP), other textual analysis, binary analysis, or statistics to identify a term in at least one of the content or the source code that relates to at least one of a routine of that is made available via the API of the service provider or a characteristic of the routine.

15. One or more computer-readable media storing computer-executable instructions, the computer-executable instructions upon execution to instruct one or more processors to perform operations comprising:
analyzing at least one of source code that is related to an Application Programming Interface (API) of a service provider or content that describes the source code or the API of the service provider;
identifying characteristics of the API of the service provider based at least in part on the analysis;
building a representation representing the characteristics of the API of the service provider; and
based at least in part on the representation, generating a client-side library of at least one of a routine or a data construct, the client-side library to provide access to at least one of a routine or a data construct that is made available via the API of the service provider.

16. The one or more computer-readable media of claim 15, wherein the representation comprises at least one of a parse tree or a graph representation.

17. The one or more computer-readable media of claim 15, wherein the client-side library comprises routines and data constructs that provide access to a set of routines and data constructs that are made available via the API of the service provider.

18. The one or more computer-readable media of claim 15, wherein the client-side library includes content that describes the API or the source code of the service provider, and the operations further comprise:
making the content of the client-side library available to an intelligent code completion tool.

19. The one or more computer-readable media of claim 15, wherein the characteristics of the API of the service provider comprise at least one of a routine of the API, a parameter of the routine, a type of the parameter, an order of at least two parameters of the routine, or a type of return of the routine.

20. The one or more computer-readable media of claim 15, wherein:
the analyzing comprises analyzing the source code that is related to the API of the service provider and analyzing the content that describes the API of the service provider;
the identifying comprises identifying a first set of characteristics of the API of the service provider based at least in part on the analysis of the source code and identifying a second set of characteristics of the API of the service provider based at least in part on the analysis of the content; and
the building comprises building a representation by adding nodes to the representation that represent the first set of characteristics of the API of the service provider and adding additional nodes to the representation that represent the second set of characteristics of the API of the service provider when the second set of characteristics comprises at least one characteristic in addition to the first set of characteristics.
